(19) United States
(12) Patent Application Publication
(10) Pub. No.: US 2007/0104042 A1
(43) Pub. Date: May 10, 2007

(54) Media drive, computer system, and media drive control method

(76) Inventors: Yoshiyuki Sugahara, Ehime (JP); Keiichi Osaka, Ehime (JP); Taisuke Miyoshi, Ehime (JP)

Correspondence Address: STEPTOE & JOHNSON LLP, 1330 CONNECTICUT AVE., NW, WASHINGTON, DC, 20036, US

(21) Appl. No.: 10/587,083

(22) PCT Filed: Jan. 19, 2005
(86) PCT No.: PCT/JP05/00595

§ 371 Date: Jul. 21, 2006

(30) Foreign Application Priority Data
Jan. 23, 2004 (JP) 2004-015011

(51) Int. Cl. G11B 17/22

(52) U.S. Cl. 369/30.32

(57) ABSTRACT

A media drive, a computer system, and a media drive control method, in which insertion/ejection of a removable medium into/from a media drive being in a sleep mode that is a power saving mode of operation can be detected, and the power consumptions of the media drive and host computer can be still more saved. When a CD-ROM drive (2) being in the sleep mode detects a change of status of a CD-ROM, such as insertion or ejection thereof, it notifies a personal computer (1) of the CD-ROM status change by using a hardware interrupt signal without polling. Thus, the status of CD-ROM insertion/ejection into/from the CD-ROM drive (2) can be grasped from the personal computer (1) to place the CD-ROM drive (2) in the sleep mode when the CD-ROM needs not be driven or in a normal mode of operation when it needs to be driven.

### TECHNICAL FIELD

The present invention relates to a media drive having a power saving mode of operation, a computer system, and a media drive control method.

### BACKGROUND ART

In a computer system where an interface (e.g., a parallel bus such as ATAPI-BUS, a serial bus such as USB or IEEE1394) connects between a removable media drive (e.g., a CD-ROM drive) and a host computer (e.g., a personal computer), generally, it is seldom that all functions of the respective devices are used continuously. Therefore, some power saving measures are usually incorporated in the computer system in order to save power.

Specifically, there is a power consumption control method of placing devices and components, each being out of use for a certain time, in a low power consumption mode. According to a well-known power consumption control method, a computer, being out of use for a certain time, is automatically switched to a standby mode and peripheral devices such as a monitor and a hard disc drive are turned off. This method is adopted as a standard function in an OS called Windows (trademark of Microsoft). In contrast to the standby mode, a status that a medium in a media drive rotates is referred to as an active mode.

These power saving measures are especially important for a notebook-size personal computer. A notebook-size personal computer uses a battery as a power supply in some cases. For such a notebook-size personal computer, a power saving measure for prolonging a battery duration as much as possible is one of crucial features.

As a conventional technique (see, e.g., JP08-87818A), for example, there is a power consumption control method of saving power when a notebook-size personal computer uses a battery. In this method, a mode of operation of a media drive connected to the notebook-size personal computer is changed in accordance with a type of a power supply to be used; thus, power consumption upon actuating the media drive is suppressed.

### DISCLOSURE OF THE INVENTION

Problem to be Solved by the Invention

However, the aforementioned conventional method disclosed in JP08-87818A is insufficient as a power saving measure. This method is definitely effective in case of using a media drive, but does not serve as a power saving measure in case of using a media drive being out of use.

For example, description will be given of a case that a CD-ROM drive is taken as an example. Some applications such as a game require a dedicated CD-ROM only at a certain moment upon start thereof or during use thereof. It is sufficient that these applications are read only at this moment. Therefore, a media drive is not entirely used during a period other than the aforementioned moment.

During a period of no access to a CD-ROM, some CD-ROM drives enter a status called a standby mode where a media drive stops rotation of a medium. Moreover, a removable medium such as a CD-ROM is not entirely used during a period from start up of a computer to shutdown of the computer in some cases. Also in such a case, a CD-ROM drive enters a standby mode.

Next, description will be given of a case that power conservation is achieved by the function of the standby mode.

FIG. 1 is a flowchart showing a media drive control method of a computer system in a conventional example 1. FIG. 2A is a flowchart showing polling upon insertion of a medium as a subroutine of FIG. 1 and FIG. 2B is a flowchart showing polling upon ejection of a medium as a subroutine of FIG. 1.

As shown in FIG. 1, first, a host computer issues, to a removable media drive, a command for notifying the host computer about an insertion status of a removable medium (S1). On the other hand, the removable media drive receives the command (S2), confirms a current status of the removable media drive, and sends, toothiest computer, status confirmation data indicating a status of the removable media drive in order to notify the host computer about the status (S3). The host computer receives the data from the removable media drive (S4), and determines whether or not the status of the removable media drive is changed, e.g., whether a removable medium is inserted or ejected (S5). If it is determined that the status of the removable media drive is changed as a result of confirmation of the status confirmation data for a removable medium (01 or 10), the host computer determines whether a removable medium is inserted or ejected (S6). If it is determined that the status of the removable media drive has no change (00), the host computer issues, to the removable media drive, a command for notifying the host computer about a status of the removable media drive again (S1).

Next, in order to determine whether a removable medium is inserted or ejected in S6, status confirmation data for the removable medium is confirmed. As a result, if it is determined that the removable medium is inserted (01), as shown in FIG. 2A, the removable media drive commences a spin-up operation so as to read information from the inserted removable medium (S7). The host computer continuously issues a status confirmation command to the removable media drive in order to confirm that the spin-up operation is completed (S8). Upon reception of the command (S9), the removable media drive sends a current status to the host computer (S10). The host computer receives the current status (S11) and determines that the spin-up operation is completed (S12). Then, the host computer is ready to read information from the removable medium (S13). Herein, the removable media drive shifts to an active mode where the removable medium rotates (S14).

If it is determined that a removable medium is ejected as a result of confirmation of status confirmation data for the removable medium, as shown in FIG. 2B, the removable media drive determines whether or not the host computer prohibits the removable media drive from ejecting the removable medium by an action that a user pushes a button (S15). If the ejection of the removable medium is permitted, the removable media drive ejects the removable medium by itself (S19) and maintains the standby mode again. If the ejection of the removable medium is prohibited by the host computer (S16), the removable media drive can not eject the removable medium by itself. Therefore, the host computer issues a medium ejection command to the removable media drive (S17). The removable media drive receives the medium ejection command (S18) to eject the removable medium.

In this standby mode, polling makes it possible to automatically start up a removable media drive upon insertion of a removable medium and to automatically stop the removable media drive up on ejection of there movable medium, which is useful. However, the removable media drive continuously consumes power due to the constant operation of the automatically activated polling, although not performing an inherent function of reading information from are movable medium. Consequently, there a rises a problem of wasteful power consumption at a certain level.

Herein, almost all devices have a status of a power saving mode of operation (generally referred to as “sleep mode”) where an amount of power to be consumed is minimum. Of course, a removable media drive such as a CD-ROM drive also has such a sleep mode. More specifically, if the aforementioned standby mode is maintained for a long time, a shift from the standby mode to the sleep mode less in power consumption than the standby mode is beneficial in light of power consumption.

Next, description will be given of a case that power conservation is further achieved by the function of the sleep mode.

FIG. 3 is a flowchart showing a media drive control method used in a case that a sleep mode is assumed to be used in a computer system in a conventional example 2.

First, a host computer issues, to a removable media drive, a command for placing the removable media drive in a sleep mode (S20). The removable media drive receives the command (S21) and, then, is shifted to the sleep mode (S22). Since the removable media drive being in the sleep mode can not respond to a command for polling, the host computer stops polling performed by issuing a command for status confirmation (S23). Next, if a user pushes a media ejection button provided in the removable media drive, the removable media drive confirms its status change (S24) to set a switch flag (S25). However, since the host computer performs no polling, the removable media drive can not notify the host computer about the status change.

In the sleep mode, as described above, if the removable media drive does not perform its inherent function of reading information from a removable medium, it is possible to detect insertion or ejection of a removable medium. In addition, the sleep mode can achieve further power conservation as compared with the standby mode. However, such power conservation is not achieved until commencement of polling; therefore, an operation for actuating a removable media drive upon insertion of a removable medium and an operation for stopping the removable media drive upon ejection of the removable medium can not be performed automatically. Thus, there arises a problem of poor usability.

Indeed, an OS never places a removable media drive such as a CD-ROM drive in a sleep mode during actuation of a computer. Hereinafter, description will be given of the reasons therefor.

A user can insert/eject a removable medium into/from a removable media drive such as CD-ROM drive. Therefore, an OS (in a host computer) issues a specific command for checking a status of the removable media drive to the removable media drive at fixed intervals in order to detect the insertion/ejection of the removable medium (polling). For example, an OS such as Windows or Macintosh (trademark of Apple Computer) displays insertion of a CD-ROM on a monitor. This can be realized in such a manner that a host computer constantly monitors a status of a removable media drive. In the removable media drive, as described above, it is necessary to respond to polling constantly commanded from the host computer.

In a sleep mode, a removable media drive can achieve the lowest power consumption, but can not respond to polling in a power saving manner. Some removable media drives have no medium ejection function. More specifically, even if a user wants to insert/eject are movable medium into/from are movable media drive in a sleep mode, a host computer can not detect such insertion/ejection; therefore, operations that can be performed in a standby mode can not be performed in the sleep mode. Due to these circumstances, the sleep mode of the removable media drive is not effectively utilized.

The present invention is made to solve the aforementioned problems. It is therefore an object of the present invention to provide a media drive, a computer system and a media drive control method. Herein, in a computer system, a media drive in a power saving mode of operation can notify a host computer about insertion/ejection of a removable medium, and the host computer effectively utilizes a power saving status of the media drive; thus, it is possible to suppress power consumption of the entire computer system when the media drive is out of use.

### Means to Solve the Problem

In order to achieve the aforementioned object, a media drive according to the present invention has a normal mode of operation and a power saving mode of operation less in power consumption than the normal mode of operation, and controls rotation of a removable medium in accordance with these modes of operation. The media drive comprises detection means for detecting ejection/insertion of the removable medium in the power saving mode of operation, and media control means for notifying an external device about detection of the ejection/insertion of the removable medium, shifting from the power saving mode of operation to the normal mode of operation in accordance with an instruction from the external device receiving the notification, and controlling rotation of the removable medium.

With this configuration, a removable media drive can notify an external device about insertion/ejection of a removable medium.

A computer system according to the present invention comprises the media drive, and a host computer connected to the media drive. The host computer includes drive control means for detecting the notification from the media drive, and instructing/controlling the media drive to shift to the normal mode of operation.

With this configuration, a host computer can grasp insertion/ejection of a removable medium into/from a removable media drive without issuing a command.

A media drive control method according to the present invention is used for allowing the host computer to control an operation of the media drive in the computer system. The media drive control method comprises a first step that the host computer places the media drive in the power saving mode of operation, a second step that the media drive shifted to the power saving mode of operation in the first step detects ejection/insertion of the removable medium, a third step that the media drive notifies the host computer about a result of the detection of the ejection/insertion of the removable medium in the second step, a fourth step that the host computer detects the notification from the media drive in the third step, a fifth step that the host computer detecting the notification from the media drive in the fourth step returns the media drive from the power saving mode of operation to the normal mode of operation, and a sixth step that the media drive returned from the power saving mode of operation to the normal mode of operation in the fifth step controls rotation of the removable medium.

With this configuration, by insertion/ejection of a removable medium into/from a removable media drive being in a power saving mode of operation, a host computer can return the removable media drive from the power saving mode of operation to a normal mode of operation.

According to another aspect of the present invention, there are provided a media drive, a computer system, and a media drive control method, for detecting ejection of a removable medium when a media ejection button is pushed and detecting insertion of a removable medium when a media insertion mechanism part is closed.

According to still another aspect of the present invention, there are provided a media drive, a computer system, and a media drive control method, for detecting ejection of a removable medium when a media insertion mechanism part is opened and detecting insertion of a removable medium when the media insertion mechanism part is closed.

According to yet another aspect of the present invention, there are provided a media drive, a computer system, and a media drive control method, for detecting only ejection of a removable medium when a media ejection button is pushed. Thus, a media drive can notify an external device that a media ejection button is pushed, and a host computer can grasp that the media ejection button of the media drive is pushed, without issuing a command. In addition, since the media ejection button of the media drive is pushed in the power saving mode of operation, the host computer can return the media drive from the power saving mode of operation to the normal mode of operation.

According to yet another aspect of the present invention, there are provided a media drive, a computer system, and a media drive control method, for detecting only ejection of a removable medium when a media insertion mechanism part is opened.

### Effects of the Invention

According to the present invention, as described above, a media drive being in a power saving mode of operation detects a change in status of a removable medium, such as insertion/ejection of the removable medium, and notifies a host computer about the status change of the removable medium by use of a hardware interrupt signal without polling. Thus, the host computer grasps insertion/ejection of the removable medium into/from the removable media drive, places the media drive in a power saving mode of operation when the removable medium must not be rotated, and places the media drive in a normal mode of operation when the removable medium must be rotated.

Accordingly, it is possible to detect insertion/ejection of a removable medium that can not be detected by a host computer in a conventional power saving mode of operation and, also, to further reduce power consumption by a media drive shifted to a power saving mode of operation and power consumption by a host computer performing no polling.

### BRIEF DESCRIPTION OF THE DRAWINGS

FIG. 1 is a flowchart showing a media drive control method in a conventional example 1.

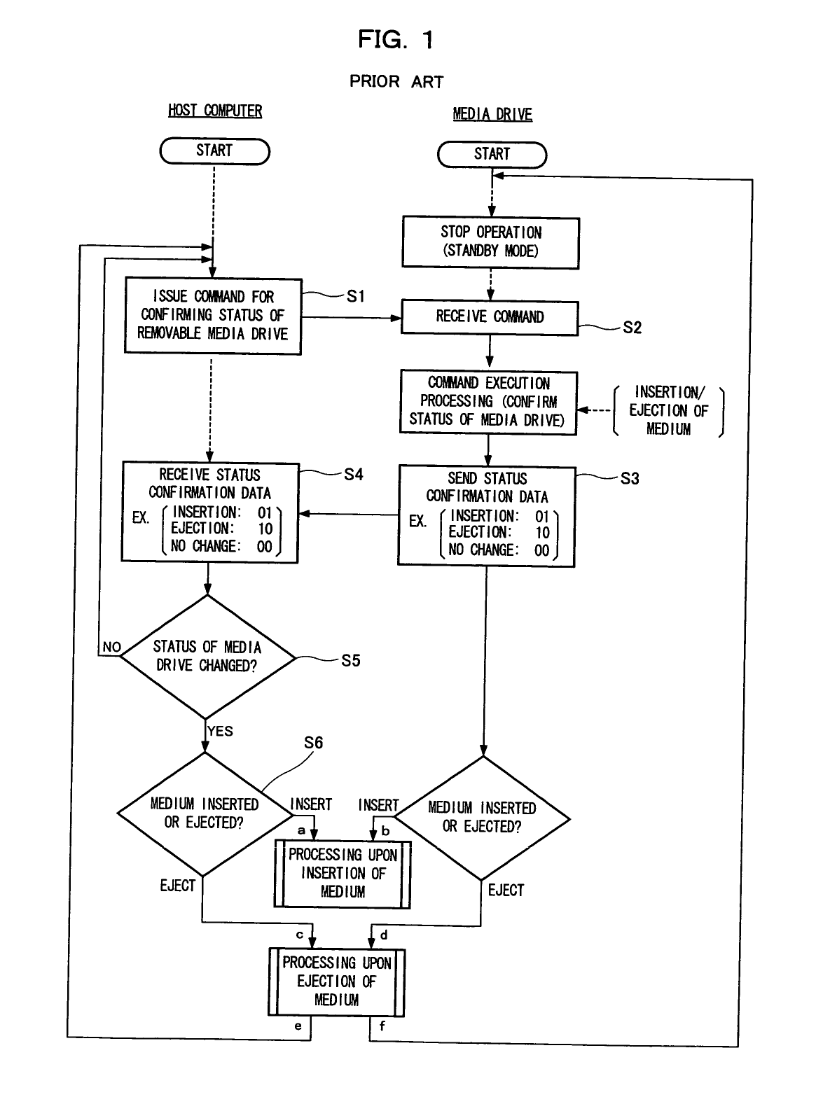

FIG. 2A is a flowchart showing polling upon insertion of a medium as a subroutine of FIG. 1, and FIG. 2B is a flowchart showing polling upon ejection of a medium as a subroutine of FIG. 1.

FIG. 3 is a flowchart showing a media drive control method in a conventional example 2.

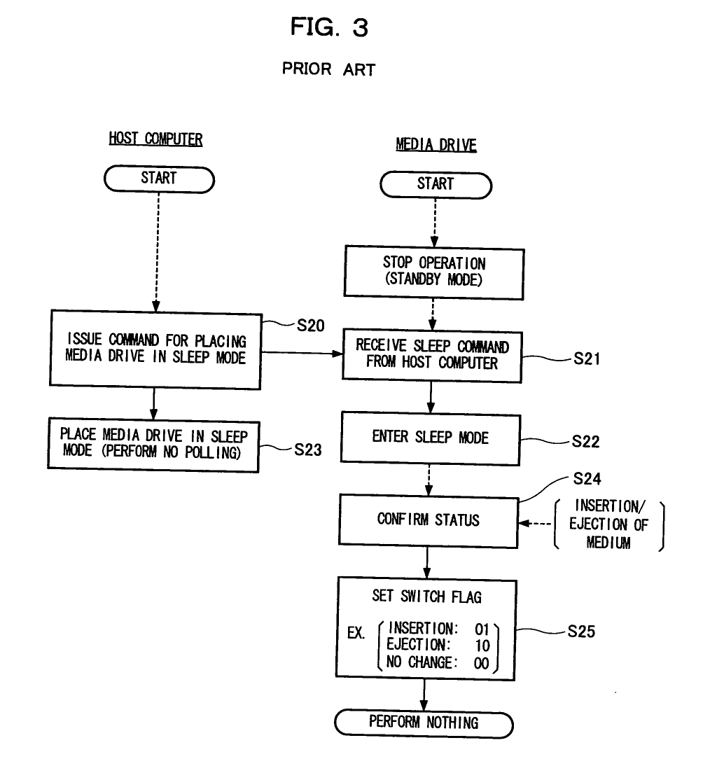

FIG. 4 is a flowchart showing a media drive control method of a computer system in an embodiment of the present invention.

FIG. 5 is a block diagram showing a configuration of a media drive and that of a host computer in the embodiment of the present invention.

FIG. 6 is a flowchart showing a media drive control method of a computer system in another embodiment of the present invention.

### BEST MODE FOR CARRYING OUT THE INVENTION

Hereinafter, detailed description will be given of a media drive, a computer system, and a media drive control method in an embodiment of the present invention with reference to the drawings.

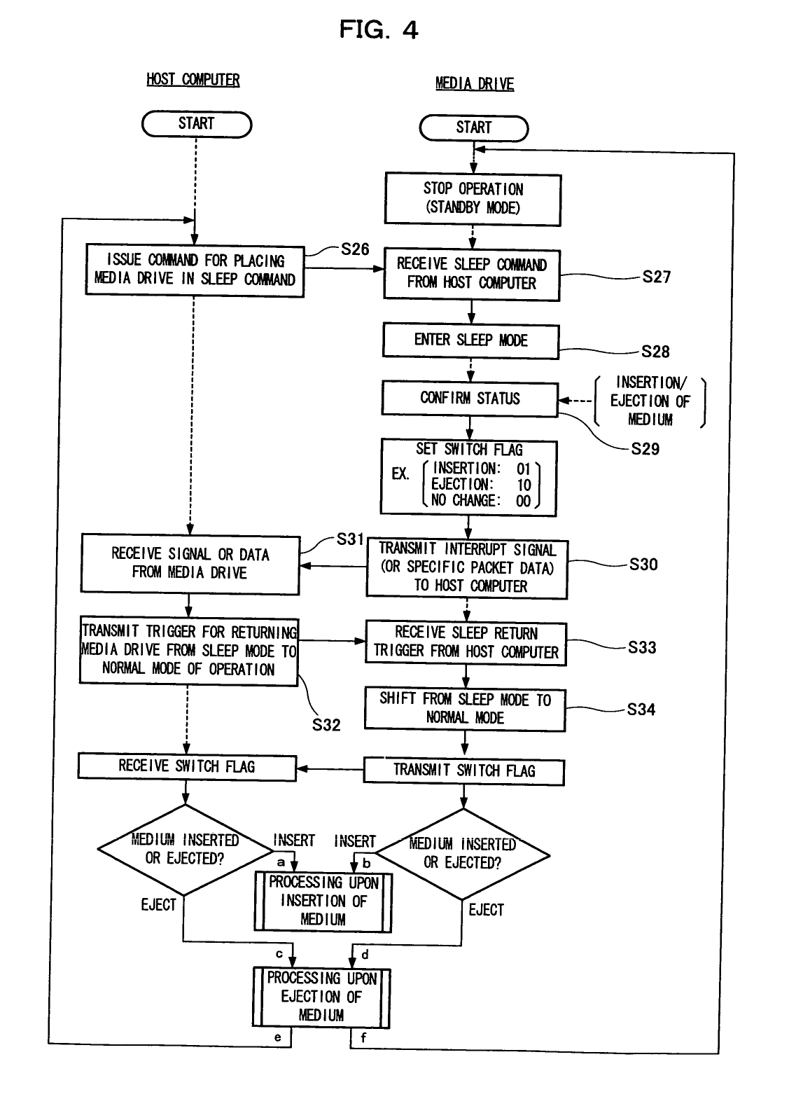

FIG. 4 is a flowchart showing the media drive control method of the computer system in the embodiment of the present invention.

Initially, description will be given of a flow from an operation that a host computer places a removable media drive in a sleep mode as a power saving mode of operation to an operation that the host computer returns the removable media drive to a normal mode of operation.

First, the host computer issues a sleep command to the removable media drive (S26). The removable media drive receives the sleep command (S27) and, then, is shifted to the sleep mode (S28). Subsequently, the removable media drive can not be subjected to polling unless the removable media drive is returned from the sleep mode to the normal mode of operation. Then, the removable media drive maintains the sleep mode until detection of insertion or ejection of a medium as a switch (hereinafter, referred to as “S/W”) detection factor (S29). Herein, examples of the S/W detection factor include open/close of a media insertion mechanism part, push of a media/tray ejection button, and the like.

Next, the removable media drive notifies the host computer about insertion or ejection of a removable medium (S30). As for a notification method, in case of parallel communication, one of signal lines in an I/F cable connecting between the removable media drive and the host computer is asserted. Alternatively, in case of serial communication, specific packet data is transmitted. Next, the host computer receives the notification made by one of the aforementioned methods (S31) and issues, to the removable media drive, a sleep return command for returning the removable media drive from the sleep mode to the normal mode of operation (S32).

The sleep return command does not necessarily take a form of a command as long as it is a factor for returning the removable media drive from the sleep mode to the normal mode of operation. Finally, the removable media drive receives the sleep return command from the host computer (S33) and, then, is returned from the sleep mode to the normal mode of operation (S34).

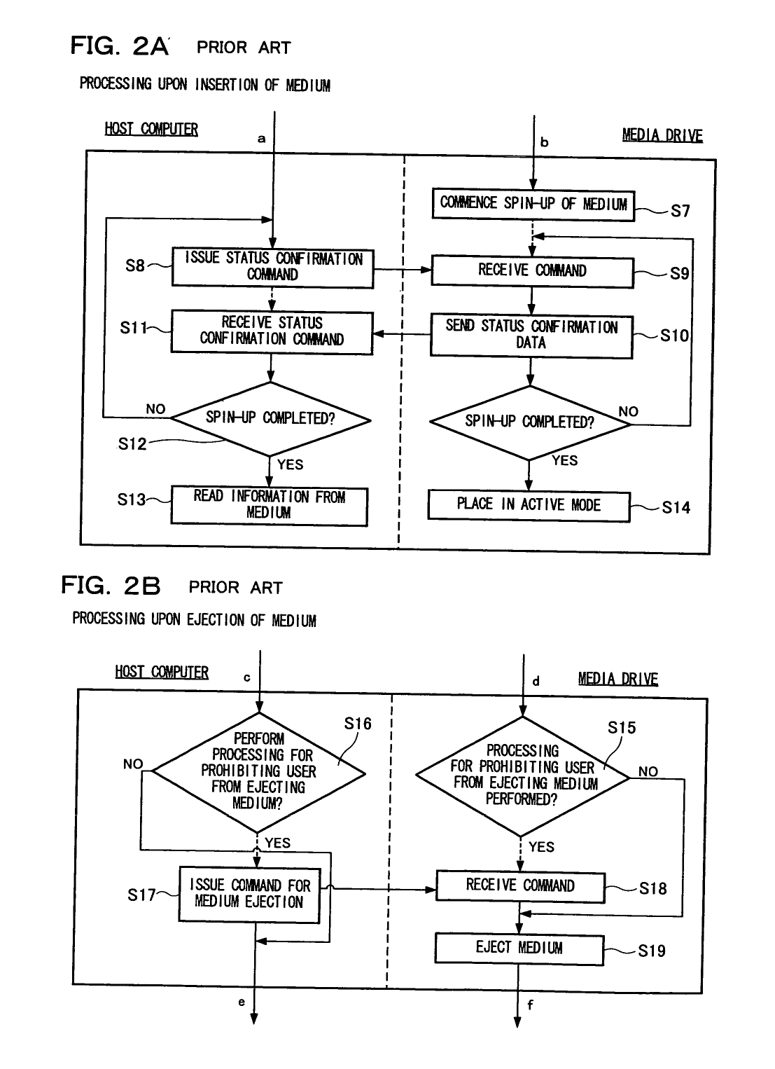

Subsequently, as in a conventional manner, the removable media drive can detect insertion or ejection of are movable medium. Thereafter, the removable media drive executes “PROCESSING UPON INSERTION OF MEDIUM” and “PROCESSING UPON EJECTION OF MEDIUM” shown in FIGS. 2A and 2B.

As for a removable media drive without requiring polling, if such a removable media drive is out of use, power consumption is reduced in a sleep mode. The removable media drive can be returned to a normal mode of operation if necessary. It is also considered a method that a removable media drive makes a notification to a host computer and, then, is returned from a sleep mode to a normal mode of operation by itself. In this case, the removable media drive notifies the host computer about return to the normal mode of operation.

Next, description will be given of a specific example of a configuration of the computer system in the embodiment of the present invention.

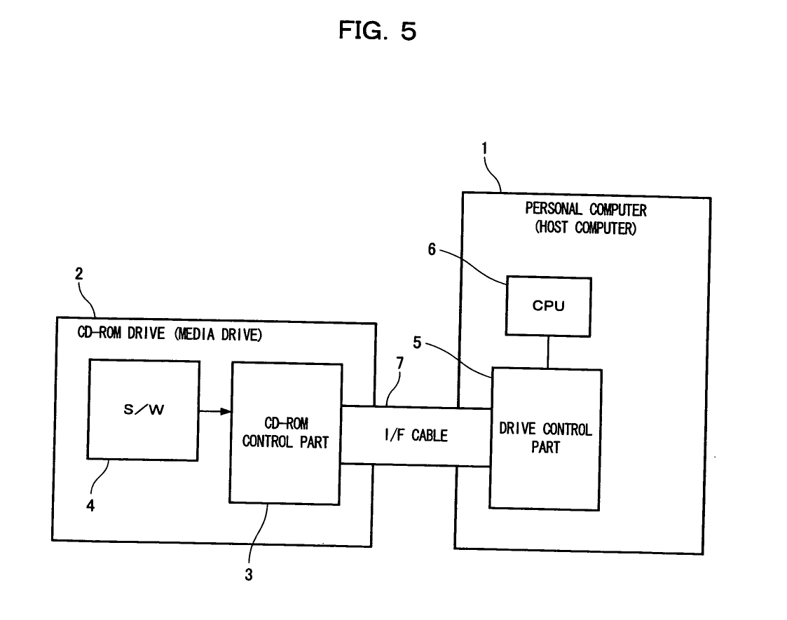

FIG. 5 is a block diagram showing a specific example of a configuration of the computer system in the embodiment of the present invention.

As illustrated in FIG. 5, the computer system includes a personal computer (a host computer) 1, a CD-ROM drive (a removable media drive) 2, a CD-ROM control part 3 for controlling actuation of the entire CD-ROM drive 2, a S/W 4 for detecting insertion or ejection of a removable medium, a drive control part 5 for controlling issue of a command to and transmission/reception of data to/from a CD-ROM drive 2 added to the personal computer 1 internally or externally, a CPU 6 for performing a computation for the control by the drive control part 5, and an I/F cable 7 for connecting between the CD-ROM drive 2 and the personal computer 1. The I/F cable 7 is used for transmitting/receiving commands and data.

If the CD-ROM drive 2 is out of use for a long time, the personal computer 1 places the CD-ROM drive 2 in the sleep mode. More specifically, the CD-ROM control part 3 receives a sleep command issued from the drive control part 5 to place the CD-ROM drive 2 in the sleep mode. In the sleep mode, the CD-ROM drive 2 receives no command; therefore, the personal computer 1 does not issue, to the CD-ROM drive 2, a polling command for detecting insertion of a removable medium. Thus, it is possible to save power to be consumed by the CPU 6 by issue of a polling command in the normal mode of operation.

Next, when a removable medium is inserted into the CD-ROM drive 2 being in the sleep mode, the S/W 4 detects the insertion of the removable medium and the CD-ROM control part 3 asserts an INTRQ signal (an interrupt signal) of the I/F cable 7. The drive control part 5 detects the assertion of the INTRQ signal, and issues a sleep return command to the CD-ROM drive 2. The description given herein takes an interruption signal as an example; however, the interruption signal does not necessarily take a form of a signal as long as the host computer can recognize a change in status of the media drive. The CD-ROM control part 3 receives the sleep return command and, then, returns the CD-ROM drive 2 from the sleep mode to the normal mode of operation. Thereafter, the personal computer 1 restarts polling for the CD-ROM drive 2 being in the normal mode of operation. Thus, the CD-ROM drive 2 can detect the insertion of the removable medium and start an application.

The description given herein takes a CD-ROM drive as an example. As for a removable media drive subjected to no polling usually, such a removable media drive is also positively shifted to a sleep mode, and is returned from the sleep mode to a normal mode of operation when a user inserts/ejects a removable medium there into/therefrom. Thus, it is possible to effectively save power for the entire removable media drive.

In the aforementioned description, a media drive being in a sleep mode notifies a host computer about occurrence of an event such as insertion/ejection of a medium. A timing for such notification is not necessarily limited to the sleep mode. Such notification may be made upon occurrence of the aforementioned event in a normal mode of operation. In addition, a type of the event to be notified is not limited to insertion/ejection of a medium, and examples thereof may include an event that a media drive calls attention to a host computer, e.g., a media drive notifies a host computer about completion of processing, and the like.

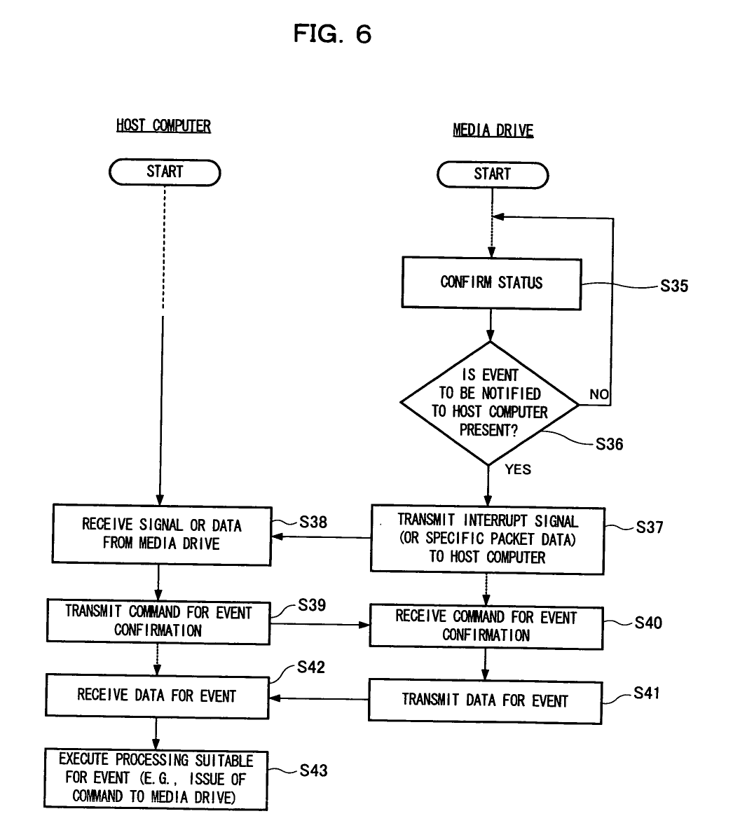

FIG. 6 is a flowchart showing an event notification method in a mode other than a sleep mode.

Also in this method, a host computer issues a command to a media drive to stop polling. The media drive being in a normal mode of operation continuously checks occurrence of an event to be notified to the host computer (S35, S36). Upon occurrence of an event, the media drive transmits an interrupt signal or specific packet data to the host computer (S37). The host computer receives the interrupt signal or the packet data from the media drive (S38) and, then, issues a command for event confirmation to the media drive in order to confirm a type of the event (S39). The media drive receives the command for event confirmation (S40) and, then, sends to the host computer data for notifying the host computer about the type of the event (S41). The host computer receives the event data from the media drive (S42) to confirm the type of the event and, then, executes processing suitable for the event, e.g., issues a specific command to the media drive (S43). Thus, it becomes possible to abolish the command polling on the host computer side even in a mode other than the sleep mode.

### INDUSTRIAL APPLICABILITY

With a media drive, a computer system, and a media drive control method according to the present invention, it is possible to detect insertion/ejection of a removable medium into/from a media drive being in a sleep mode as a power saving mode of operation and further save power consumed by a media drive and a host computer. The present invention is applicable to a media drive having a sleep mode and a computer system.

1. A media drive having a normal mode of operation and a power saving mode of operation less in power consumption than the normal mode of operation and controlling rotation of a removable medium in accordance with these modes of operation, the media drive comprising:
detection means for detecting ejection/insertion of the removable medium in the power saving mode of operation; and
media control means for notifying an external device about detection of the ejection/insertion of the removable medium, shifting from the power saving mode of operation to the normal mode of operation in accordance with an instruction from the external device receiving the notification, and controlling rotation of the removable medium.

2. A computer system comprising the media drive according to claim 1, and a host computer connected to the media drive, the host computer including drive control means for detecting the notification from the media drive, and instructing/controlling the media drive to shift to the normal mode of operation.

3. A media drive control method for allowing the host computer to control an operation of the media drive in the computer system according to claim 2, the media drive control method comprising:
a first step that the host computer places the media drive in the power saving mode of operation;
a second step that the media drive shifted to the power saving mode of operation in the first step detects ejection/insertion of the removable medium;
a third step that the media drive notifies the host computer about a result of the detection of the ejection/insertion of the removable medium in the second step;
a fourth step that the host computer detects the notification from the media drive in the third step;
a fifth step that the host computer detecting the notification from the media drive in the fourth step returns the media drive from the power saving mode of operation to the normal mode of operation; and
a sixth step that the media drive returned from the power saving mode of operation to the normal mode of operation in the fifth step controls rotation of the removable medium.

4. A media drive having a normal mode of operation and a power saving mode of operation less in power consumption than the normal mode of operation and controlling rotation of a removable medium in accordance with these modes of operation, the media drive comprising:
detection means for detecting that a media ejection button is pushed for ejecting the removable medium and that a media insertion mechanism part is closed by insertion of the removable medium in the power saving mode of operation; and
media control means for notifying an external device about the detection that the media ejection button is pushed or the media insertion mechanism part is closed, shifting from the power saving mode of operation to the normal mode of operation in accordance with an instruction from the external device receiving the notification, and controlling rotation of the removable medium.

5. A computer system comprising the media drive according to claim 4, and a host computer connected to the media drive, the host computer including drive control means for detecting the notification from the media drive, and instructing/controlling the media drive to shift to the normal mode of operation.

6. A media drive control method for allowing the host computer to control an operation of the media drive in the computer system according to claim 5, the media drive control method comprising:
a first step that the host computer places the media drive in the power saving mode of operation;
a second step that the media drive shifted to the power saving mode of operation in the first step detects that the media ejection button is pushed or that the media insertion mechanism part is closed;
a third step that the media drive notifies the host computer about a result of the detection that the media ejection button is pushed or the detection that the media insertion mechanism part is closed in the second step;
a fourth step that the host computer detects the notification from the media drive in the third step;
a fifth step that the host computer detecting the notification from the media drive in the fourth step returns the media drive from the power saving mode of operation to the normal mode of operation; and
a sixth step that the media drive returned from the power saving mode of operation to the normal mode of operation in the fifth step controls rotation of the removable medium.

7. A media drive having a normal mode of operation and a power saving mode of operation less in power consumption that the normal mode of operation and controlling rotation of a removable medium in accordance with these modes of operation, the media drive comprising:
detection means for detecting that a media insertion mechanism part is opened by ejection of the removable medium and that the media insertion mechanism part is closed by insertion of the removable medium in the power saving mode of operation; and
media control means for notifying an external device about the detection that the media insertion mechanism part is opened or the detection that the media insertion mechanism part is closed, shifting from the power saving mode of operation to the normal mode of operation in accordance with an instruction from the external device receiving the notification, and controlling rotation of the removable medium.

8. A computer system comprising the media drive according to claim 7, and a host computer connected to the media drive, the host computer including drive control means for detecting the notification from the media drive, and instructing/controlling the media drive to shift to the normal mode of operation.

9. A media drive control method for allowing the host computer to control an operation of the media drive in the computer system according to claim 8, the media drive control method comprising:
a first step that the host computer places the media drive in the power saving mode of operation;
a second step that the media drive shifted to the power saving mode of operation in the first step detects that the media insertion mechanism part is opened or that the media insertion mechanism part is closed;
a third step that the media drive notifies the host computer about a result of the detection that the media insertion mechanism part is opened or the detection that the media insertion mechanism part is closed in the second step;
a fourth step that the host computer detects the notification from the media drive in the third step;
a fifth step that the host computer detecting the notification from the media drive in the fourth step returns the media drive from the power saving mode of operation to the normal mode of operation; and
a sixth step that the media drive returned from the power saving mode of operation to the normal mode of operation in the fifth step controls rotation of the removable medium.

10. A media drive having a normal mode of operation and a power saving mode of operation less in power consumption than the normal mode of operation and controlling rotation of a removable medium in accordance with these modes of operation, the media drive comprising:
detection means for detecting that a media ejection button is pushed for ejecting the removable medium in the power saving mode of operation; and
media control means for notifying an external device about the detection that the media ejection button is pushed, shifting from the power saving mode of operation to the normal mode of operation in accordance with an instruction from the external device receiving the notification, and controlling rotation of the removable medium.

11. A computer system comprising the media drive according to claim 10 and a host computer connected to the media drive, the host computer including drive control means for detecting the notification from the media drive, and instructing/controlling the media drive to shift to the normal mode of operation.

12. A media drive control method for allowing the host computer to control an operation of the media drive in the computer system according to claim 11, the media drive control method comprising:
a first step that the host computer places the media drive in the power saving mode of operation;
a second step that the media drive shifted to the power saving mode of operation in the first step detects that the media ejection button is pushed;
a third step that the media drive notifies the host computer about a result of the detection that the media ejection button is pushed in the second step;
a fourth step that the host computer detects the notification from the media drive in the third step;
a fifth step that the host computer detecting the notification from the media drive in the fourth step returns the media drive from the power saving mode of operation to the normal mode of operation; and
a sixth step that the media drive returned from the power saving mode of operation to the normal mode of operation in the fifth step controls rotation of the removable medium.

13. A media drive having a normal mode of operation and a power saving mode of operation less in power consumption than the normal mode of operation and controlling rotation of a removable medium in accordance with these modes of operation, the media drive comprising:
detection means for detecting that a media insertion mechanism part is opened by ejection of the removable medium in the power saving mode of operation; and
media control means for notifying an external device about the detection that the media insertion mechanism part is opened, shifting from the power saving mode of operation to the normal mode of operation in accordance with an instruction from the external device receiving the notification, and controlling rotation of the removable medium.

14. A computer system comprising the media drive according to claim 13 and a host computer connected to the media drive, the host computer including drive control means for detecting the notification from the media drive, and instructing/controlling the media drive to shift to the normal mode of operation.

15. A media drive control method for allowing the host computer to control an operation of the media drive in the computer system according to claim 14, the media drive control method comprising:
a first method that the host computer places the media drive in the power saving mode of operation;
a second step that the media drive shifted to the power saving mode of operation in the first step detects that the media insertion mechanism part is opened;
a third step that the media drive notifies the host computer about a result of the detection that the media insertion mechanism part is opened in the second step;
a fourth step that the host computer detects the notification from the media drive in the third step;
a fifth step that the host computer detecting the notification from the media drive in the fourth step returns the media drive from the power saving mode of operation to the normal mode of operation; and
a sixth step that the media drive returned from the power saving mode of operation to the normal mode of operation in the fifth step controls rotation of the removable medium.
